(19) United States
(12) Patent Application Publication
(10) Pub. No.: US 2026/0094171 A1
(43) Pub. Date: Apr. 2, 2026

(54) SYSTEM AND METHOD FOR PROVIDING A CHARTER FLIGHT EXCHANGE

(71) Applicant: Jessica Fisher, Brooklyn, NY (US)

(72) Inventor: Jessica Fisher, Brooklyn, NY (US)

(21) Appl. No.: 19/050,630

(22) Filed: Feb. 11, 2025

Related U.S. Application Data
(60) Provisional application No. 63/702,259, filed on Oct. 2, 2024.

(51) Int. Cl. G06Q 30/08; G06Q 10/02

(52) U.S. Cl. CPC G06Q 30/02; G06Q 30/08; G06Q 10/02; G06Q 30/0623; G06Q 30/0641

(57) ABSTRACT

Exemplary systems and methods are directed to a dynamic flight exchange configured for re-selling charter flight assets through plural provider dashboards. A user interface receives a user interface including plural parameters that correspond to the first interactive display of one of the plural provider dashboards. The plural parameters being associated with one of the sale or the purchase of a target charter flight asset. The processor can initiate an exchange event including one of a query or an online an online auction for the target charter flight asset associated with user input. The processor receives data from the server in response to the user input and generates a second interactive having an arrangement of data based on results of the exchange event. The user interface receives a user response to the arrangement of data and the processor controls the exchange event on the network based on the user response.

### FIELD

The present disclosure relates to exchange network, and more particularly to systems and method for providing a charter flight exchange for the resale of charter flight assets.

### BACKGROUND

Aircraft provider companies provide private flights to individuals. Many of these aircraft providers leverage use of charter brokers to aid in booking individuals on their flights. The charter brokers obtain flight information from the aircraft providers. The flight information typically includes aircraft model, space/seat information, routes, and times. This information is obtained verbally, by phone, and sometimes via other means of transmitting information, including by an application programming interface (API) designed to interface between the aircraft provider and the charter broker. After obtaining the flight information, charter brokers typically communicate aircraft and/or flight information to end-user customers verbally and/or by email and add some fee to the cost of the flight for his/her services. With electronically transmitted information, the broker stores the flight information in a database and provides (e.g., via a website or software application) the flight information to individuals upon request.

The charter broker model for booking flights is inefficient in that there is a significant lag time in a consumer of charter flight assets (i.e., aircraft/space/seat) receiving updated information from an aircraft provider. Further, the broker model does not allow for the purchase of charter flight assets for a single legs of a multi-leg charter flight schedule. In addition, the broker model provides no viable way in which an aircraft provider can resell previously purchased charter flight assets including jet card hours.

Furthermore, the broker model does not allow for the booking of “empty legs” (which occur when a plane must move between points, or a route requires pick-up points), which are often heavily discounted, a large network of consumers will enable cost-saves while simultaneously enabling greater utilization of aircraft, and therefore greater profit-potential for Aircraft Providers (including aircraft owners and operators).

### SUMMARY

An exemplary method for a dynamic flight exchange is disclosed. The method comprising: storing, in memory of a computing device, program code for generating a dynamic flight exchange; executing, by a processor of the computing device, the program code stored in memory, the program code causing the computing device to be configured to execute operations including: generating, by the processor, an application programming interface for generating plural provider dashboards, each provider dashboard providing a first interactive display for a sale or purchase of charter flight assets; receiving, by a user interface of the processing device, a user input corresponding to the first interactive display of one of the plural provider dashboards, the user input including plural parameter values parameters associated with one of the sale or the purchase of a target charter flight asset; initiating, by the processor, a peer-to-peer exchange event on a network by querying at least one remote database based on the user input associated with the purchase of the target charter flight asset; receiving, by the processor, data in response to exchange event from the network, the data including information obtained in response to the query or data in response to the sale of the target charter flight asset; generating, by the user interface, a second interactive display including an arrangement of data received in response to the exchange event, the second interactive display being configured to accept a user response to the arrangement of data; receiving, by the user interface, the user response to the arrangement of data; and controlling, by the processor, the exchange event on the network based on the user response.

An exemplary system for a dynamic flight exchange is disclosed. The system comprising: memory configured for storing program code for generating a dynamic flight exchange; a processor configured to execute the program code stored in memory, the program code causing the processor to be configured to generate an application programming interface for generating plural provider dashboards, each provider dashboard providing a first interactive display for a sale or purchase of charter flight assets; a user interface configured to receive a user input corresponding to the first interactive display of one of the plural provider dashboards, the user input including plural parameter values parameters associated with one of the sale or the purchase of a target charter flight asset; the processor being configured to: initiate a peer-to-peer exchange event on a public network, the exchange event including one of: a query of at least one remote database based on the user input associated with the purchase of the target charter flight asset, and an online auction based on the user input associated with the sale of the target charter flight asset; receive data in response to exchange event, the data including information obtained in response to the query or data in response to the sale of the target charter flight asset; the user interface being configured to: generate a second interactive display including an arrangement of data received in response to the exchange event, the second interactive display being configured to accept a user response to the arrangement of data; and receive the user response to the arrangement of data; and the processor being configured to control the exchange event on the network based on the user response.

An exemplary non-transitory computer readable medium storing program code for a dynamic flight exchange, when placed in communicable contact with a computing device, the computer readable medium causing the computing device to be configured to: generate, by a processor, an application programming interface for generating plural provider dashboards, each provider dashboard providing a first interactive display for a sale or purchase of charter flight assets; receive, by a user interface, a user input corresponding to the first interactive display of one of the plural provider dashboards, the user input including plural parameter values parameters associated with one of the sale or the purchase of a target charter flight asset; initiate, by the processor, a peer-to-peer exchange event on a public network the exchange event including one of: a query of at least one remote database based on the user input associated with the purchase of the target charter flight asset, and an online auction based on the user input associated with the sale of the target charter flight asset; receive, by the computing device, data in response to exchange event, the data including information obtained in response to the query or data in response to the sale of the target charter flight asset; generate, by the user interface, a second interactive display including an arrangement of data received in response to the exchange event, the second interactive display being configured to accept a user response to the arrangement of data; and receive, by the user interface, the user response to the arrangement of data; and control, by the processor, the exchange event on the network based on the user response.

### DESCRIPTION OF THE DRAWINGS

The scope of the present disclosure is best understood from the following detailed description of exemplary embodiments when read in conjunction with the accompanying drawings. Included in the drawings are the following figures:

FIG. 1 illustrates a system a dynamic flight exchange in accordance with an exemplary embodiment.

FIGS. 2 to 24 illustrate interactive displays of a mobile device in accordance with an exemplary embodiment of the present disclosure.

FIG. 25 illustrates a method for a dynamic flight exchange in accordance with an exemplary embodiment.

FIG. 26 illustrates a hardware configuration of a computing device architecture in accordance with an exemplary embodiment of the present disclosure.

Further areas of applicability of the present disclosure will become apparent from the detailed description provided hereinafter. The detailed description of exemplary embodiments is intended for illustration purposes only and are, therefore, not intended to necessarily limit the scope of the disclosure.

### DETAILED DESCRIPTION

Aspects of the technical solution include systems, apparatuses, and methods for managing routes and travel planning. The technical solution is rooted in computer technology in that specially programmed computing devices are used to remove the need to use application programming interfaces that are specific to the aircraft providers thereby reducing a lag time in providing updated flight information.

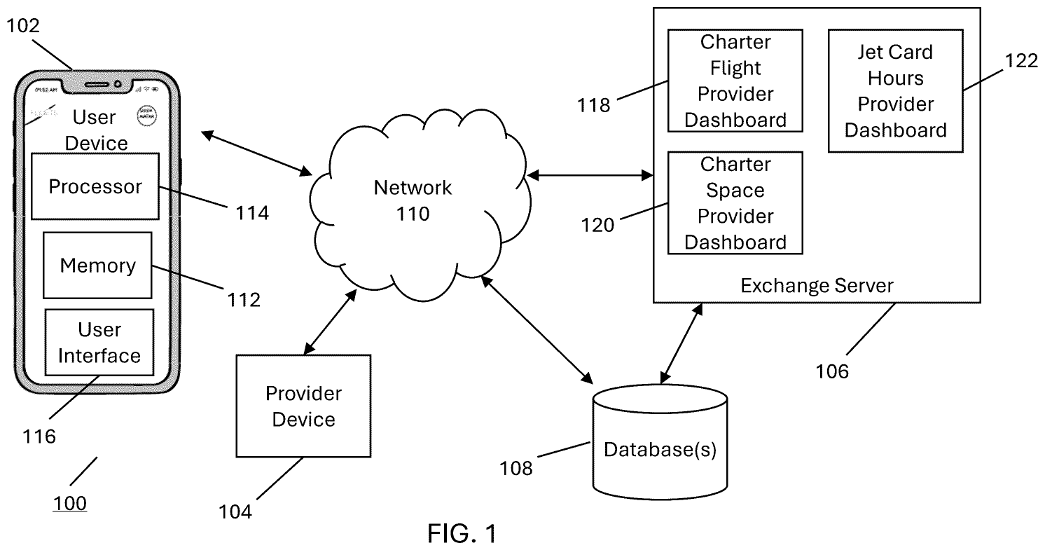

FIG. 1 illustrates a system a dynamic flight exchange in accordance with an exemplary embodiment.

As shown in FIG. 1, a system 100 for a dynamic flight exchange as disclosed herein can include at least one user device 102, a provider device 104, an exchange computer 106, a database 108, that are connected to communicate over a network 110. The user device 102 and provider device 104 can be configured as a computing device, including for example a desktop computer, laptop computer, mobile computing device such as a smart phone or tablet device, or any other suitable device as desired. Each computing device can include memory 112 and a processor 114. The memory 112 can be configured for storing program code for generating a dynamic flight exchange and communicating as a peer device or client device on a network. The processor 114 can execute the program code stored in memory 112, the program code causing the processor 114 to be configured to generate an application programming interface for generating plural provider dashboards, each provider dashboard providing a first interactive display for a sale or purchase of charter flight assets. The user device 102 can be configured to establish communication with the provider device 104 to receive data for populating the interactive displays of the plural provide dashboards generated by the application programming interface. The user device 102 can also include a user interface 116 that is configured to display interactive graphical features of the application programming interface. The user device 102 configured to receive a user input corresponding to the first interactive display of one of the plural provider dashboards, the user input including plural parameter values parameters associated with one of the sale or the purchase of a target charter flight asset. The exchange computer 106 can be configured as a host computer that includes a combination of hardware and software for permitting access to the exchange network, resources, and data by one or more computing devices. According to another exemplary embodiment, the exchange computer 106 can be configured as an exchange server that includes a combination of hardware, software, and data for providing operating data and resources to client computing devices for the charter flight exchange.

The target charter flight asset can include previously purchased space(s) on a charter flight, previously purchased jet card hours for use with a charter flight, and previously purchased charter flights. Once the user input is received, the processor can initiate a peer-to-peer exchange event on a public network. For example, if the target charter flight asset includes one or more previously purchased space(s) for resale, the user input can include a flight date, a flight route, a static price value for the one or more seats on the charter flight, or any other suitable search parameter as desired.

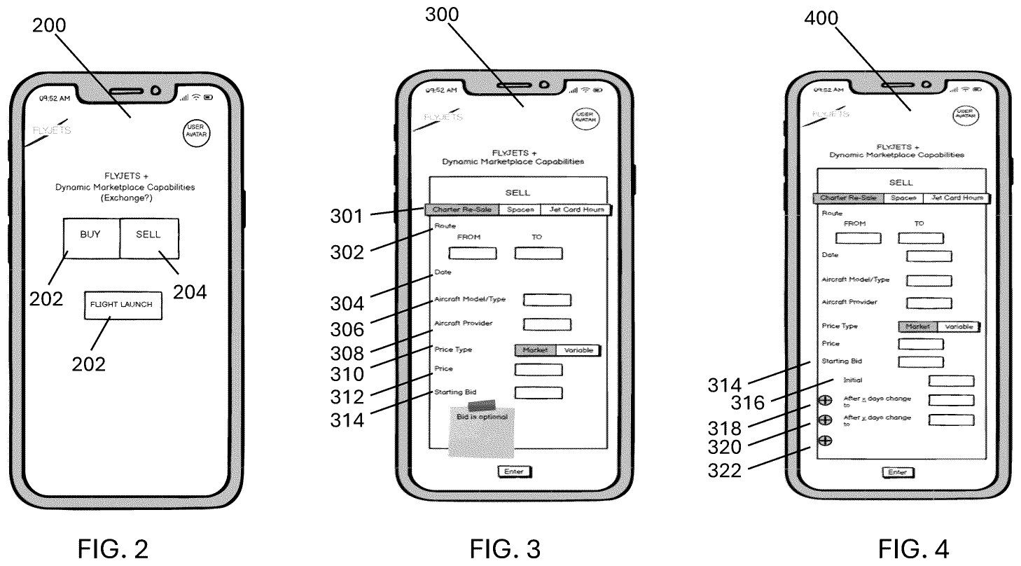

FIG. 2 illustrates an interactive display of a provider dashboard in accordance with an exemplary embodiment of the present disclosure. As shown in FIG. 2, the user interface 116 can display a first interactive display 200 which allows a user to launch one of the plural provider dashboards. For example, the plural provider dashboards can include one or more dashboards for initiating new flight request which can include buying charter flight assets 202 on the dynamic flight exchange or selling charter flight assets 204 including, for example, the re-sale of previously purchased charter flights, spaces on charter flights, or jet card hours on the dynamic flight exchange. Once the user determines the action to be taken, the flight launch link button can be selected to for navigating to a series of interactive displays for performing the buying or selling the charter flight asset. According to an exemplary embodiment, each interactive display in a sequence can be displayed through one or more of a drop-down menu, a pop-up screen or menu, a transition to a new window, or any other suitable display as desired. According to an exemplary embodiment, the transition to a new window can include any number of graphic effects including scrolling, fading, dissolving, wiping, cutting, or any other suitable transition as desired.

FIGS. 3-6 illustrate interactive displays associated with a provider dashboard for selling flight assets on a dynamic flight exchange in accordance with an exemplary embodiment of the present disclosure. As shown in FIGS. 3-6, a provider, such as those who have purchased charter flights or operators themselves, can list booked charters and offer spaces on charter flights or a charter aircraft for individual re-sale. In FIG. 3, the interactive display 300 is associated with the sale or re-sale of previously purchased charter flight assets. As shown in FIG. 3, the interactive display 300 includes a banner 301 which allows a user to select the type of charter flight asset that is to be listed for sale. For example, the charter flight asset can include the re-sale of previously purchased charter flights, previously purchased spaces such as a charter aircraft available for reservation, and the user input can include one or more of a route 302 including a take-off location and a destination location, a date of flight 304, an aircraft model and type 306, an aircraft provider/operator 308, a price type 310 which indicates whether the price is set to a market value or set to be variable, a price 312, a starting bid 314, and any other charter flight information as desired, including, for example, an operator safety rating, a number of spaces for sale, an allowance for pets. According to an exemplary embodiment, the user or seller can select or indicate whether the charter flight asset is to be sold through an online auction format. FIG. 4 illustrates an interactive display 400 of the user interface 116 that is displayed in response to a user's input of starting bid 314 in the interactive display 300. As shown in FIG. 4, after the starting bid is input the interactive display 400 will allow the user to input an initial or starting bid 316. The interactive display also includes an option for changing the bid if the initial bid is not matched. For example, the user can provide a value to which the initial bid is to change if after a specified number of days 316, 320, the initial bid is not matched. The user can have the initial bid change in this manner a multiple number of times 322. According to an exemplary embodiment, a provider of the exchange can set a maximum num er of initial bid changes available for a starting bid 314.

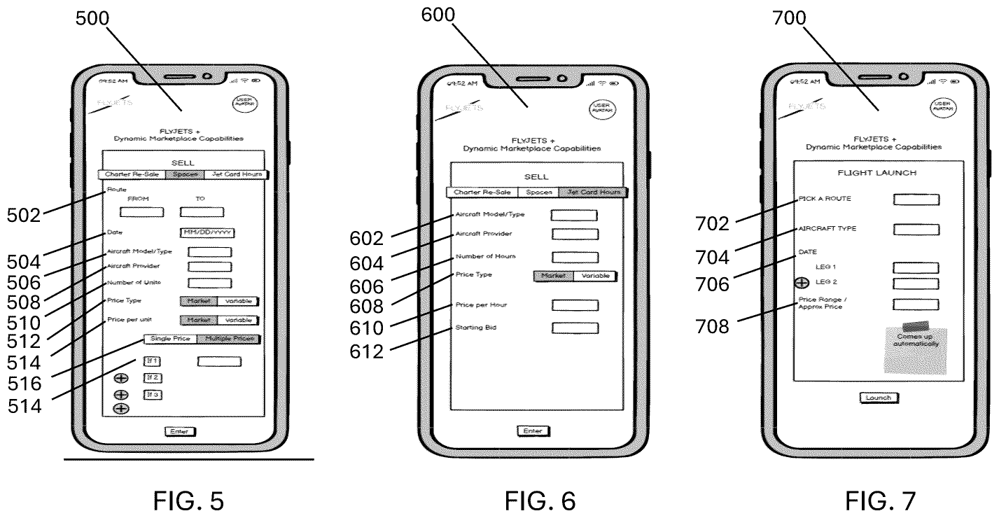

FIG. 5 illustrates an interactive display 500 that allows the user to input information for selling a charter flight asset associated with a space on a charter flight. As shown in FIG. 5, the Spaces can be listed at market (outright) prices or variable (changeable) prices, the latter of which may be set to increase or decrease over specific time periods as set by the provider via the provider device 104. For each space available on a charter flight, the provider device 104 can upload information to the exchange computer 106 that is configured to host the exchange through the one or more interactive displays of a provider dashboard 118, 120, 122.

According to an exemplary embodiment, the jet card hours dashboard 122 can list jet card hours at market (outright) prices or variable (changeable) prices, the latter of which may be set to increase or decrease over specific time periods set by the provider device 104. The provider device 104 can configure the dashboard by uploading information for listing jet card hours that are available for purchase. The information can include, for example, the aircraft model/type associated with the sale, and the number of hours for sale in a given time interval. The information can be uploaded to the exchange computer 106 and stored in a database associated with the Jet Card Provider dashboard.

The fields for accessing the spaces available on a charter flight include one or more of: a route 502 including a take-off location and a destination location, a date of flight 504, an aircraft model and type 506, an aircraft provider/operator 508, a number of spaces (e.g., units) for sale 510, a price type 512 which indicates whether the price is set to a state market value or set to be variable, a price per unit 514 which indicates whether each unit is to have a static market prices or variable price, a selection for indicating whether each space will have the same or a single price or whether for each space will have a different price 516. If the user options for each space to have a different sale price, then, the interactive display allows the user to enter a value for each space 518 depending on the value provided in the number of units for sale field 510.

In FIG. 6, the interactive display 600 of the provider exchange allows the user to input information for selling or reselling a charter flight asset such as jet card hours for use with a charter flight. As shown in FIG. 6, the interactive display 600 can include fields for input information associated with an aircraft type 602, an aircraft provider 604, a number of hours being sold 606, a price type 608 which indicates whether the price is set to a static market value or a variable value, a price per hour 610, and a starting bid option 612, and any other suitable field as desired.

Once the asset sale information is input to the provider exchange through one or more of the interactive displays of FIGS. 3-6, the information is uploaded to the provider exchange computer 106 over the network 110 and stored in the database 108. Depending on the asset being sold, the exchange computer 106 can access the user information for populating one of the charter flight dashboard 118, Charter Space Dashboard 120, or the Jet Card Hours Dashboard 122 associated with the asset.

FIG. 7 illustrates an interactive display for purchasing a charter flight asset on the dynamic flight exchange system in accordance with an exemplary embodiment. As shown in FIG. 7, the interactive display 700 can include fields for the user to input information, such as, a flight route 702, an aircraft type 704, a date for travel 706 including an option for specifying one or more legs of the flight, and a price range or approximate price for the purchase 708, or any other suitable field for specifying a charter flight asset for purchase as desired. Once the user has entered the information of FIG. 7, the provider exchange for buying a charter flight asset is launched.

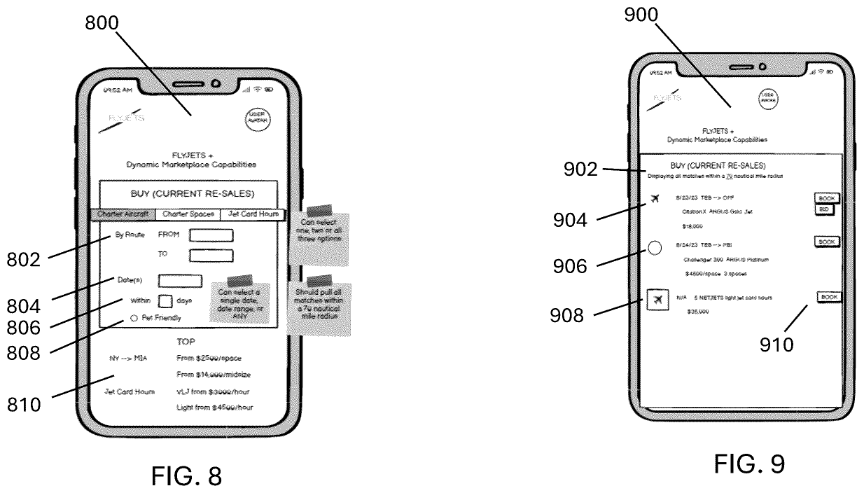

FIGS. 8-20 illustrate interactive displays for purchasing a charter flight asset on the dynamic flight exchange system in accordance with an exemplary embodiment. In FIG. 8, an interactive display 800 is shown that allows a user to input specified information for initiating a search for charter aircraft flights for purchase. As shown in FIG. 8, the user can specify a route 802 including a departure location and an arrival location, a date 804 for travel. The display 800 can also include a field 806 for the user to specify a date range which includes the specified date 804. Further, the display 800 can include an option of indicating whether pet accommodations 808 are required. According to an exemplary embodiment, the display 800 can include a dynamic listing 810 which identifies top selections for charter flight assets available for purchase. The dynamic listing 810 can include flights for preferred routes, preferred aircraft providers, preferred prices, or any other preference available for selection or identification by the user on the provider exchange. According to an exemplary embodiment, the dynamic listing 810 can select charter flight assets according to a prior purchase or search history of the user that is stored in the database 108 an accessible by the exchange computer 106.

Once the charter flight asset information of FIG. 8 is submitted to the exchange computer 106, the exchange computer can perform a query on the database to identify charter flight assets that match the parameters set by the user. FIG. 9 illustrates an interactive display 900, which includes an exemplary listing of query results returned by the exchange computer according to the asset parameters entered by the user through the display of FIG. 8. As shown in FIG. 9, the exchange computer can return matching assets that are within a specified distance 902, such as a 70 nautical mile radius. A default radius can be set by the provider in the exchange computer, or the user can set a preferred maximum distance for the query results. For each asset listed, the interactive display 900 can include plural icons which indicate whether additional information associated with the specified listing is available. For example, an icon 904 can indicate that no pictures of the aircraft associated with the listing are available for viewing. An icon 906 can indicate that one or more pictures of the aircraft associated with the listing are available for viewing. The icon 906 is an activable link which when allows pictures to be downloaded from the exchange computer or from a network location. The icon 908 can indicate that the listing is for jet card hours. The interactive display 900 also includes plural icons which 910 allowing the user to book the charter flight or submit a bid, which is based on the parameters set by the provider when posting the charter flight asset for sale.

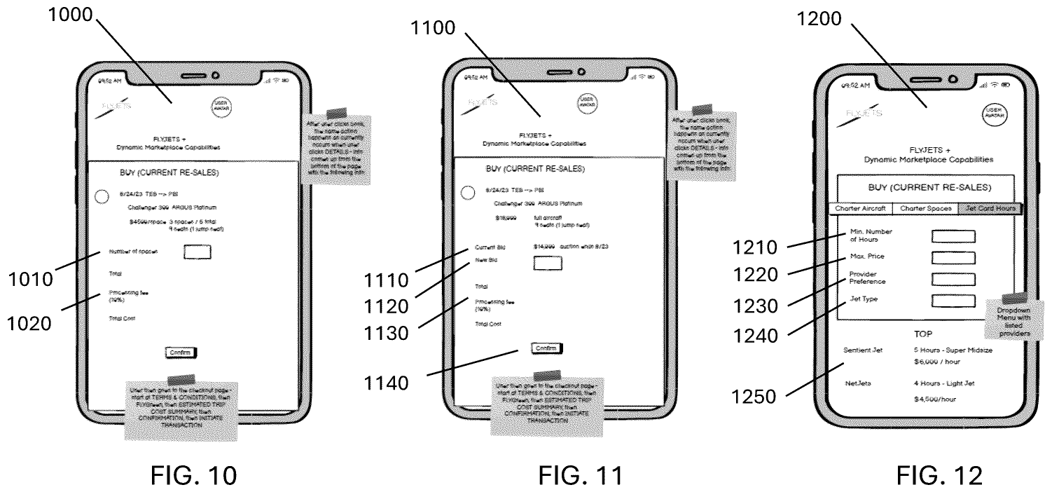

FIG. 10 illustrates an interactive display 1000 that is displayed by the user interface 116 based on data received from the exchange computer 106 when the user selects the icon 910 to book one of the exemplary listings shown in FIG. 9. As shown in FIG. 10, the user can specify the number of spaces 1010 that are to be purchased. Once this information is entered, exchange computer 106 can return information 1020 populating the fields associated with assets to be purchased and the purchase price. When the user confirms the purchase information by selecting the confirm icon 1030, the user is directed to a checkout page, which displays terms and conditions of the sale, a summary of the estimated cost of the trip, and links to complete the transaction.

FIG. 11 illustrates an interactive display 1100 that is displayed by the user interface 116 based on data received from the exchange computer 106 when the user selects the icon 910 to bid on one of the exemplary listings shown in FIG. 9. As shown in FIG. 11, the interactive display can display the current high bid for the asset 1110 and allow the user to input a new bid 1120 for the asset. Once the new bid 1120 is input, the exchange computer 106 can return information 1130 populating the fields associated with assets to be purchased and the purchase price. When the user confirms the purchase information by selecting the confirm icon 1140, the user is directed to a checkout page, which displays terms and conditions of the sale, a summary of the estimated cost of the trip, and links to complete the transaction.

FIG. 12 illustrates an interactive display 1200, which allows a user to input information for searching the exchange computer 106 for jet card hours that are available for purchase. As shown in FIG. 12, the interactive display 1200 includes fields for receiving information from the user regarding the minimum number of hours to be purchased 1210, a maximum price for purchase 1220, a charter provider preference 1230, a jet type 1240, or any other suitable information as desired. According to an exemplary embodiment, the display 1200 can include a dynamic listing 1250 which identifies top selections for charter flight assets available for purchase by providers. The dynamic listing 1250 can include flights for preferred routes, preferred aircraft providers, preferred prices, or any other preference available for selection or identification by the user on the provider exchange. According to an exemplary embodiment, the dynamic listing 1250 can select charter flight assets according to a prior purchase or search history of the user that is stored in the database 108 an accessible by the exchange computer 106.

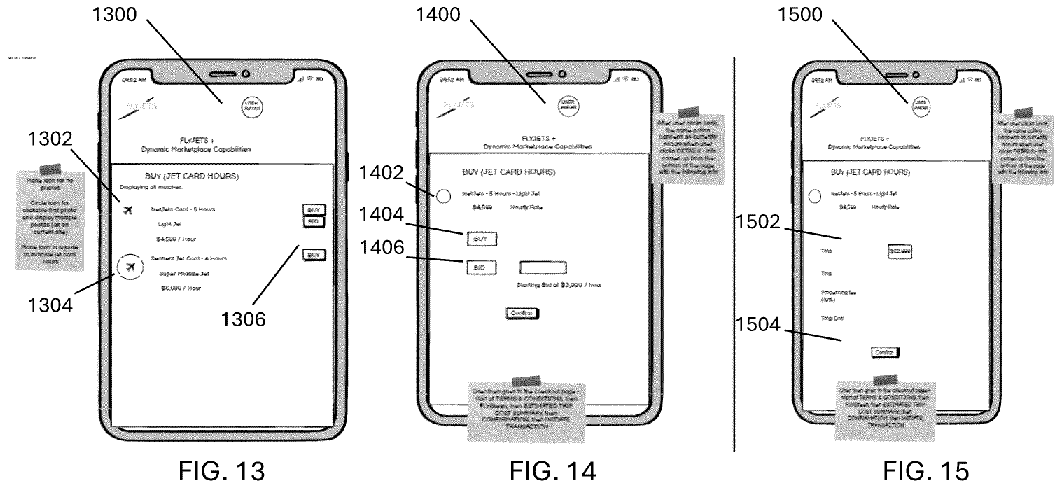

Once the jet card hours information of FIG. 12 is submitted to the exchange computer 106, the exchange computer 106 can perform a query on the database to identify jet card hour assets that are available for purchase and match the parameters set by the user. FIG. 13 illustrates an interactive display 1300, which includes an exemplary listing of query results returned by the exchange computer 106 according to the asset parameters entered by the user through interactive display 1200. As shown in FIG. 13, for each jet card hours asset listed, the interactive display 1300 can include plural icons which indicate whether additional information associated with the specified listing is available. For example, an icon 1302 can indicate that no pictures of the aircraft associated with the listing are available for viewing. An icon 1304 can indicate that one or more pictures of the aircraft associated with the listing are available for viewing. The icon 1304 can be configured as an activable link which when allows pictures to be downloaded from the exchange computer 106 or from a network location. The interactive display 1300 also includes plural icons which 1306 allowing the user to book the charter flight or submit a bid, which is based on the parameters set by the provider when posting the charter flight asset for sale.

FIG. 14 illustrates an interactive display 1400 that is displayed by the user interface 116 based on data received from the exchange computer 106 when the user selects one of exemplary listings of the interactive display 1300 which has a buy or bid option. As shown in FIG. 14, the interactive display 1400 can display information 1402 on the jet card asset that has been selected. The interactive display 1400 can further include a graphical icon 1404 for selecting a buy option for the jet card asset, and a graphical icon 1406 for selecting a bid option for participating in an online auction for purchasing the jet card asset. A value field 1408 is provided for the user to enter a bid. According to an exemplary embodiment, when the user's bid is a starting bid that initiates the online auction, the interactive display 1400 can include additional information detailing at least a minimum starting bid. According to another exemplary embodiment, when the user's bid is joining an online auction already in progress, the interactive display 1400 can show information detailing a current highest bid for the asset. Based on the user selects to buy 1404 or bid 1406 on the jet card asset, the user can confirm the selection and input information (e.g., current bid) and the user device 102 communicates the input information to the exchange computer 106. As shown in FIG. 15, the exchange computer can return information such that the interactive display 1500 of the user interface 116 shows a total purchase price and total cost 1502 for the assets to be purchased. When the user confirms the purchase information by selecting the confirm icon 1504, the user is directed to a checkout page, which displays terms and conditions of the sale, a summary of the estimated cost of the trip, and links to complete the transaction.

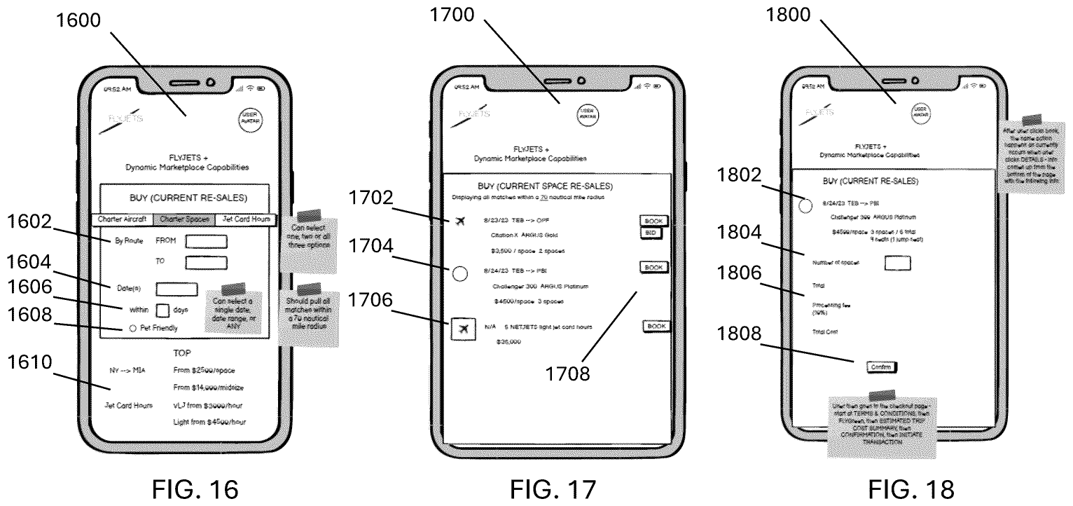

FIG. 16 illustrates an interactive display 1600 which allows the use to input search parameters for charter flight spaces that are available for purchase. As shown in FIG. 16, the interactive display 1600 can include fields specifying a route 1602 including a departing location and an arrival location. The fields can also include date(s) for travel 1604, where the user can specify a single date for travel or define a data range 1606 within which the travel is to take place. Further, the user can define whether pet accommodations are preferred 1608. According to an exemplary embodiment, the display 1600 can include a dynamic listing 1610 which identifies top selections for charter flight assets available for purchase from providers.

Once the charter flight space information of FIG. 16 is submitted to the exchange computer 106, the exchange computer 106 can perform a query on the database to identify jet card hour assets that are available for purchase and match the parameters set by the user. FIG. 17 illustrates an interactive display 1700, which includes an exemplary listing of query results returned by the exchange computer 106 according to the asset parameters entered by the user through interactive display 1600. As shown in FIG. 17, for charter flight space asset listed, the interactive display 1700 can include plural icons which indicate whether additional information associated with the specified listing is available. For example, an icon 1702 can indicate that no pictures of the aircraft associated with the listing are available for viewing. An icon 1704 can indicate that one or more pictures of the aircraft associated with the listing are available for viewing. The icon 1704 can be configured as an activable link which when allows pictures to be downloaded from the exchange computer 106 or from a network location. An icon 1706 can be configured to provide information on jet card hours that meet the space requirements of the user's search parameters. The interactive display 1700 also includes plural icons which 1708 allowing the user to book (e.g., buy) the charter flight or submit a bid, which is based on the parameters set by the provider when posting the charter flight asset for sale.

FIG. 18 illustrates an interactive display 1800 based on the user's selection of a listing shown in the interactive display 1700. As shown in FIG. 18, the interactive display 1800 can provide detail information 1802 of the charter flight space listing that was selected for booking. The interactive display 1800 can also provide a field 1804 for receiving a user's entry of the number of spaces that are to be purchased from the selected listing. Based on the value of field 1804, the interactive display 1800 can update purchase information 1806 including a total number of assets, a processing fee applied to the sale, and total cost to the user/purchaser. When the user confirms the purchase information by selecting the confirm icon 1808, the user is directed to a checkout page, which displays terms and conditions of the sale, a summary of the estimated cost of the trip, and links to complete the transaction.

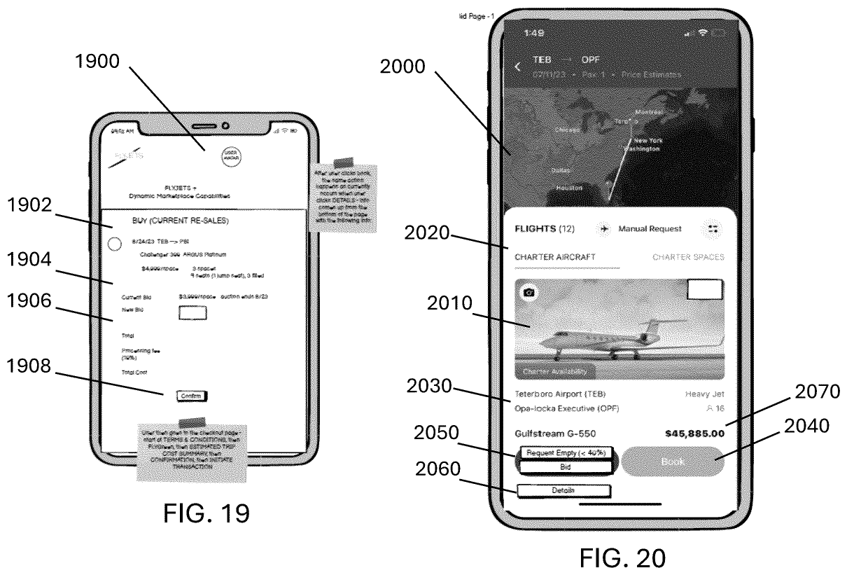

FIG. 19 illustrates an interactive display 1900 based on the user's selection of a listing shown in the interactive display 1700. As shown in FIG. 18, the interactive display 1900 can provide detail information 1902 of the charter flight space listing that was selected for booking. The interactive display 1900 can also provide a field 1904 for receiving a user's bid for participating in an online auction for the number of spaces that to be purchased from the selected listing. Associated with the field 1904, the interactive display 1900 can include detail information on a current bid of the user and/or a current highest bid of the online auction. Based on the value of field 1904, the interactive display 1900 can update purchase information 1906 including a total number of assets, a processing fee applied to the sale, and total cost to the user/purchaser. When the user confirms the purchase information by selecting the confirm icon 1908, the user is directed to a checkout page, which displays terms and conditions of the sale, a summary of the estimated cost of the trip, and links to complete the transaction.

FIG. 20 illustrates an interactive display 2000 which is displayed on the user interface 116 based on the user's selection of an icon associated with a query listing returned to the user device 102 from the exchange computer 106. As shown in FIG. 20, the interactive display 2000 includes one or more photographs 2010 of the aircraft associated with the charter flight asset available for purchase 2020. The interactive display 2000 can also include information identifying the owner of the aircraft 2030. Interactive icons 2040, 2050, and 2060 can be provided for booking the charter flight asset, submitting a bid in an online auction for purchasing the charter flight asset, and additional details on the charter flight asset, respectively. Further, the interactive display 2000 can include information identifying the type of aircraft 2070 and a current sale price of the charter flight asset.

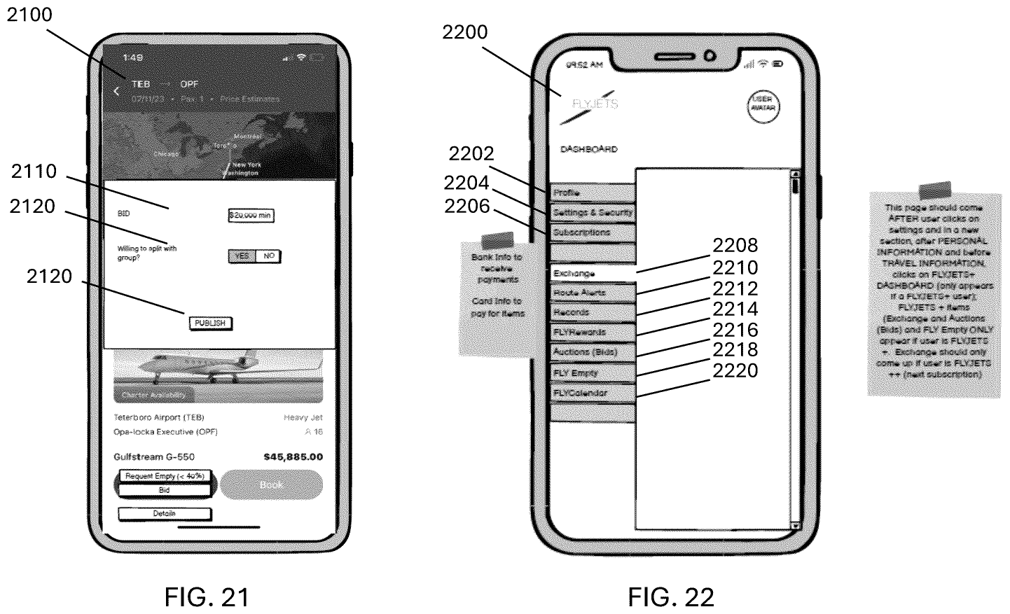

FIG. 21 illustrates an interactive display 2100 which is displayed based on the user's selection of the bid icon 2050 in interactive display 2000. As shown in FIG. 21, upon the user's selection, the user can be prompted to enter the value of the bid in field 2110, determine whether the bid is to be split among plural users in a specified group in field 2020, and publish the information of fields 2110 and 2020. interactive display 2100 can associated with a query listing returned to the user device 102 from the exchange computer 106.

FIG. 22 illustrates an interactive display 2200 which provides interactive links allowing a user to specify settings and preferences 2202 in the provider dashboard as it relates to profile information, settings & security 2204 for the application programming interface, provider subscriptions 2206 for which the user is registered, provider exchange information 2208, route alerts 2210 for preferred routes associated with charter flight assets, records 2212, provider rewards program information and user status 2214, bid status 2216 for pending online auctions, an provider empty information 2018, and a provider calendar 2220, and/or any other user settings or preferences as desired. The exchange computer 106 can send data for populating the interactive links on display 2200. For example, one or more links of the interactive display 2200 are only displayed when the user is a registered member of a provider's service. For example, links 2208, 2214, 2216, 2218, and 2220 require a provider subscription for access.

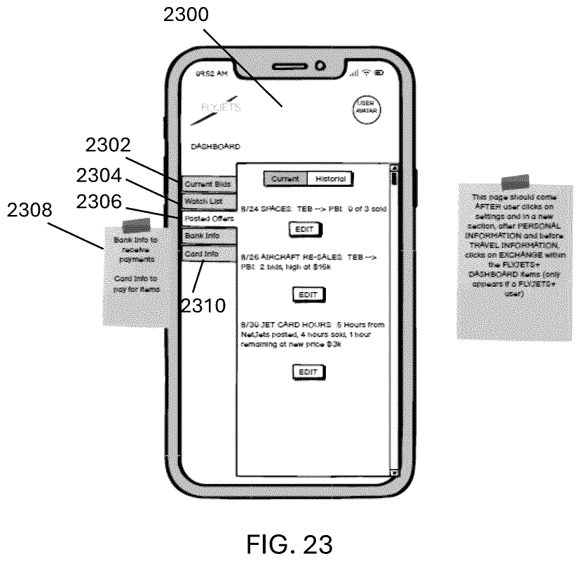

FIG. 23 illustrates an interactive display 2300 which is displayed based on the user's selection of the provider exchange information link 2208 in the interactive display 2200 of FIG. 22. As shown in FIG. 23, the interactive display 2300 can include interactive links that provide information on current bids 2302, a watch list 2304 of charter flight assets, the user's posted offers 2306, banking information 2308 for booking and bidding on charter flight assets, card information 2310 for booking and bidding on charter flight assets, and any additional interactive links as desired by the provider. The interactive display 2300 can allow a user to make changes to posted offers that are in pending status. For example, a user may be able to edit a current offer related to one or more charter flight assets.

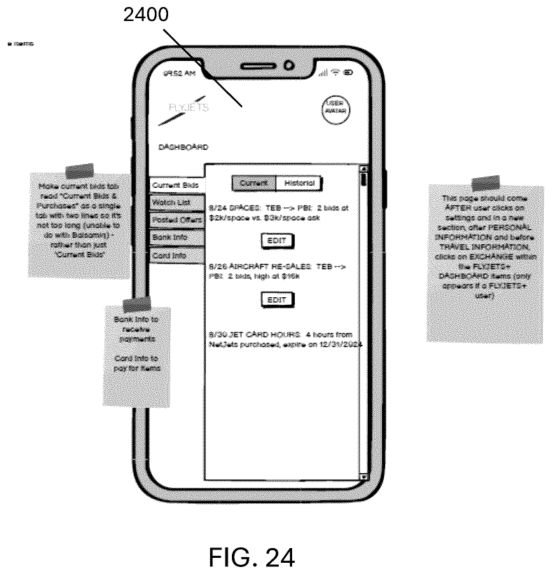

FIG. 24 illustrates an interactive display 2400 which is displayed based on the user's selection of the current bid interactive link 2302 of the interactive display 2300 of FIG. 23. As shown in FIG. 24, the interactive display 2400 display detailed information on each user's bid that is currently pending on the dynamic exchange.

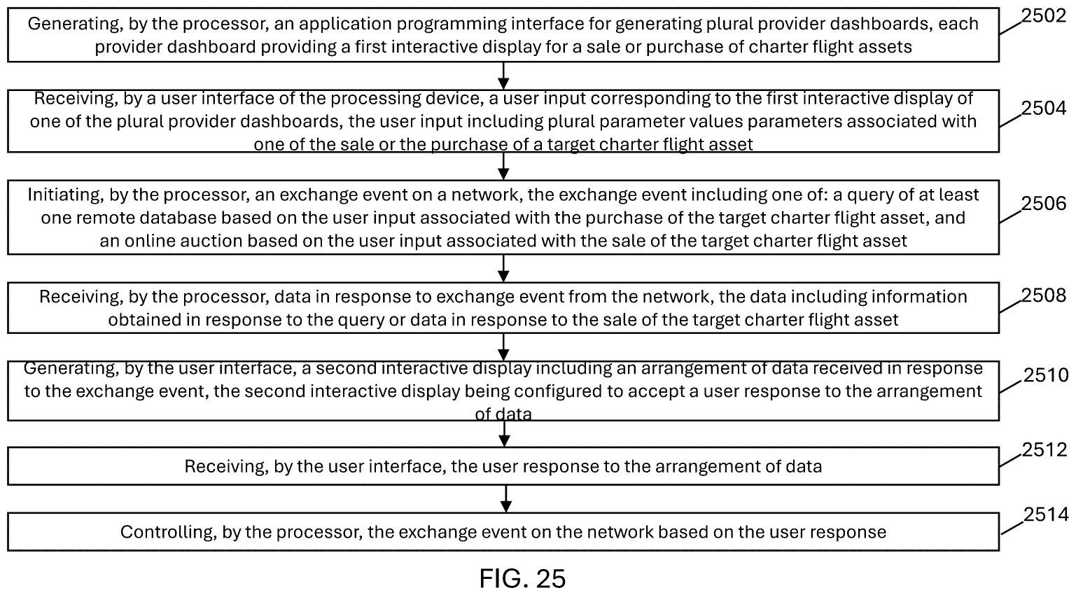

FIG. 25 illustrates a method for a dynamic flight exchange in accordance with an exemplary embodiment.

As shown in FIG. 25, step 2502 includes generating, by the processor 114, an application programming interface for generating plural provider dashboards, each provider dashboard providing a first interactive display for a sale or purchase of charter flight assets. The user interface 116 of the processing device (e.g., user device 102) receives a user input corresponding to the first interactive display of one of the plural provider dashboards (Step 2504). The user input includes plural parameter values associated with one of the sale or the purchase of a target charter flight asset. As already discussed, the target charter flight asset can include one or more spaces available on a charter flight, and the user input can include at least a flight date, a flight route, and a static price value for the one or more spaces on the charter flight, or any other suitable parameter as desired. According to another exemplary embodiment, the user input can include a flight date, a variable price value for the one or more spaces available on the charter flight, an updated variable price associated with a number of spaces to be purchased. In another embodiment, the target charter flight asset includes jet card hours available for use and the user input can include at least a number of hours for sale, a price per hour at a market rate, a starting bid value. In yet another exemplary embodiment, the target charter flight asset includes a charter aircraft available for reservation and the user input includes a flight date, a flight route, a variable price value, a starting bid, a time interval for updating the variable price value, and an updated variable price associated with the time interval.

Step 2506 includes initiating, by the processor 114, a peer-to-peer exchange event on a network, the exchange event including one of: a query of at least one remote database based on the user input associated with the purchase of the target charter flight asset, and an online auction based on the user input associated with the sale of the target charter flight asset. According to an exemplary embodiment, the exchange event can include a query of at least one remote database based on the user input associated with the purchase of the target charter flight asset. The query can occur via a peer-to-peer connection on a network. For example, an exchange event for spaces available for sale or purchase on charter-flights can be implemented via a provider dashboard 118, 120, 122, such that information related to the spaces can be stored in a database in association with the provider dashboard and presented to a user via one or more interactive displays. The initiation operation can include the user device 102 communicating with the exchange computer 106 over the network 110. The exchange computer 106 being configured to communicate with multiple user devices or computing devices on the network 110, such as sending and receiving information associated with the online auction and information associated with the availability, status, location, or any other suitable information as desired that is related charter flight assets available for resale on the dynamic exchange. For example, the exchange computer 106 can be configured to communicate a status of an auction, a current bid of the auction, a time elapsed in the auction, a time remaining in the auction, and/or any other suitable information as desired. Further, the exchange computer 106 can be configured to communicate whether a target charter flight asset has been sold or purchased, a location of the aircraft associated with the target charter flight asset, and a status of the aircraft associated with the target charter flight asset. The user device 102 can receive data from the exchange computer 106 in response to the exchange event, the data including information obtained in response to the query or data in response to the sale or purchase of one or more target charter flight assets.

According to another exemplary embodiment, the exchange event can include an online auction based on the user input associated with the sale of the target charter flight asset. The exchange event can be implemented by a provider dashboard 118, 120, 122 which lists previously purchased charter flights for purchase/booking either in whole or in-part. The provider device 104 can upload information for the charter flight re-sale to the exchange computer 106 for populating the associated provider dashboard 118, 120, 122, which information can be stored in a database 108 associated with the dashboard. The information can include, for example, a date of flight, a take-off and destination inputs, an aircraft model and type, an aircraft operator (optional), an operator safety rating, a number of spaces for sale, an allowance for pets, and any other suitable information as desired. Each dashboard 118, 120, 122 includes one or more interactive displays that are launched in sequence, and which show the provider-listed sales of “charter e-sales” through a search engine. The interactive displays can be used to initiate an exchange event based on a user entering, for example, a date of desired flight and take-off and destination inputs, which can include a “within radius” for breadth of the search. The user device 102 generates a query based on the user input. The query is sent to the exchange computer 106 for conducting the search, and the server returns search results to the user device 102 that match or are related to the user input.

According to an exemplary embodiment, the processor 114 of the user device 102 can generate a query signal based on the user input to the user interface 116. Through the one or more interactive displays, the user can enter a date of desired flight and take-off and destination inputs, which can include a “within radius” designation for locations to provide wider breadth in the search. According to an exemplary embodiment, the user input provides the plural parameters for performing a query for the target charter flight asset, such as one or more space(s) for purchase, jet card hours for purchase and use with a charter flight, the re-sale of previously purchased charter flights. The processor 114 can transmit the query signal to the exchange computer 106 over the network 110. The exchange computer 106 can perform the query on the specified one or more databases 108 and obtain a query result including no target charter flight assets or a list of one or more candidate target charter flight assets. The exchange computer 106 can populate the associated provider dashboard 118, 120, 122 with the query information and send the query results to the user device 102 over the network 110.

As shown in FIG. 25, the processor 114 of the user device 102 receives data from the exchange computer 106 in response to the exchange event over the network 110 (step 2508). The processor 114 generates a signal instructing the user interface 116 to generate one or more interactive displays of an associated provider dashboard 118, 120, 122. For example, the exchange computer 106 can receive the user parameters and return information according to one of charter flight dashboard 118, charter space dashboard 120, or jet card hours dashboard 122. The user can access the Jet Card Provider dashboard 122 by a specified interactive display provided on the user's computing device. The user can initiate the exchange event by proving a user input including information related to jet card hours desired for purchase. According to another exemplary embodiment, the user can initiate the exchange event for purchasing jet card hours by entering a date of desired flight and take-off and a destination, which can include a “within radius” designation for breadth of the query. The data returned to the user device 102 by the exchange computer 106 includes information obtained in response to the query or data in response to the sale of the target charter flight asset. The user interface 116 generates a second interactive display including an arrangement of data received in response to the exchange event (step 2510). According to an exemplary embodiment, the second interactive display can be configured to accept a user response to the arrangement of data. The second interactive display can include new bid values in response to a previous bid value of the online auction. Based on the query results, the processor of the computing device can cause the user interface to generate a second interactive display which includes a list of candidate charter flight assets returned in response to the query. For example, the second interactive display can include candidate space(s), candidate jet card hours, or candidate charter flights or aircraft that match the search parameters included in the user input. The second interactive display can be configured to accept a user response to the arrangement of data. The second interactive display can include icons and/or buttons which allow the user to select one of the candidate target charter flight assets for purchase. For example, upon finding desired results, a user can select a specified icon and/or button to purchase/book the desired space or jet card hours, after which the user is navigated to another interactive display including terms and conditions of the purchase and an administrative fee associated with the purchase. The user selects a specified button and/or icon on the interactive display to accept the terms and conditions and the administrative fee. Upon acceptance, the computing device generates a purchase/booking request signal that is sent to the provider device 104 via the exchange computer 106 for accepting the request. If the request is accepted, the provider device 104 sends an electronic contract to the user device 102 over the network 110 via the exchange computer 106. According to an exemplary embodiment, the provider device 104 may send the electronic contract to the user device 102 via a peer-to-peer connection over the network 110. In another exemplary embodiment, the provider device 104 can send the electronic contract to the user device 102 through an application program interface such that the user device 102 generates another interactive display including for displaying the electronic contract to the user. According to another exemplary embodiment, the provider device 102 can send the electronic contract to the user according to another communication platform such as electronic mail, short messaging service (SMS), or another suitable platform as desired.

As shown in FIG. 15, step 2512 includes receiving, by the user interface 116 of the user device 102, the user response to the arrangement of data. The user device 102 can control the exchange event being run on the exchange computer 106 based on the user response (step 2514). For example, the processor 114 sends a signal over the network 110 for instructing the exchange computer 106 to close the online auction or to change the availability to purchase and/or status of a charter flight asset based on the user's response. According to an exemplary embodiment, the user interface 116 can generate a third interactive display for completing purchase of a selected candidate charter flight asset from a list of candidate charter flight assets received in response to the query. Once the information for completing the purchase is entered and submitted, the user device 102 can send a signal, generated by the processor 114, over the network 110 to remove a selected candidate charter flight asset from available charter flight assets. According to another exemplary embodiment, the user interface 116 can generate a third interactive display for completing the purchase of a target charter flight asset, when a current bid for the target charter flight asset is the highest bid at the closing of the auction. Once the information for completing the purchase is entered and submitted, the user device 102 can send a signal to the exchange computer 106 over the network to change the availability status of the associated target charter flight asset.

While the above embodiments have been described with respect to flyer users and aircraft providers, the methods and systems discussed herein may also be applied to additional movable vehicles that operate in a “non-scheduled” capacity including, for example, cars, trucks, boats, jet skis, and the like. In such instances, references to the Flyer/users discussed above may be considered the passengers of the movable vehicle.

The exemplary system and methods of the present disclosure can be implemented using a number and arrangement of systems, hardware, and/or modules (e.g., software instructions). For example, the system can include a combination of two or more systems, hardware, and/or modules or may be implemented within a single system, hardware, and/or module. A single system, hardware, and/or module may be implemented as multiple, distributed systems, hardware, and/or modules. Additionally, or alternatively, a set of systems, a set of hardware, and/or a set of modules (e.g., one or more systems, one or more hardware devices, one or more modules) may perform one or more functions described as being performed by another set of systems, another set of hardware, or another set of modules.

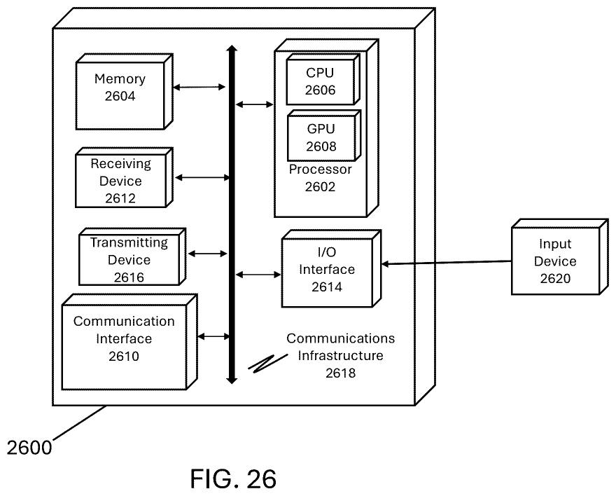

FIG. 26 illustrates a hardware configuration of a computing device architecture in accordance with an exemplary embodiment of the present disclosure.

The computing system 2600 disclosed herein can be implemented in a configuration suitable for assessing housing security risks according to the described exemplary embodiments. For example, various components of the system 2600 may be implemented in one or more computing devices (e.g., one or more servers, client devices, user devices, and/or the like) and the one or more computing devices may be connected via a communications network (e.g., the Internet).

The computing system 2600 may include a processor 2602 (e.g., CPU) and memory 2604. The processor 2602 may execute software instructions (e.g., program code) for assessing housing risks according to the one or more algorithms described herein. The system 2600 as disclosed herein, can be configured for training machine learning and/or artificial intelligence models (e.g., neural models, neural networks, and/or the like) and for assessing housing risks.

The processor 2602 may be implemented in hardware, software, or a combination of hardware and software. For example, the processor 2602 may include a common processor (e.g., a CPU) 2606, a graphics processing unit (GPU) 2608, an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or execute software instructions to perform a function. Any of the processors disclosed herein can include any integrated circuit or other electronic device (or collection of devices) capable of performing an operation on at least one instruction, which can include a Reduced Instruction Set Core (RISC) processor, a CISC microprocessor, a Microcontroller Unit (MCU), a CISC-based Central Processing Unit (CPU), a Digital Signal Processor (DSP), a Field Programmable Gate Array (FPGA), etc. The hardware of such devices may be integrated onto a single substrate (e.g., silicon “die”), or distributed among two or more substrates. Various functional aspects of the processor may be implemented solely as software or firmware associated with the processor.

The processor 2602 can include one or more processing or operating modules. A processing or operating module can be a software or firmware operating module configured to implement any of the functions disclosed herein. The processing or operating module can be embodied as software and stored in memory. The memory being operatively associated with and communicably coupled to the processor. A processing module can be embodied as a web application, a desktop application, a console application, etc.

The processor 2602 can include or be associated with a computer or machine readable medium. The computer or machine-readable medium can include memory. Any of the memory discussed herein can be computer readable memory configured to store data. The memory can include a volatile or non-volatile, transitory, or non-transitory memory, and be embodied as an in-memory, an active memory, a cloud memory, etc. As already discussed, examples of memory can include flash memory, Random Access Memory (RAM), Read Only Memory (ROM), Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor.

Memory 2604 may include random access memory (RAM), read-only memory (ROM), and/or another type of dynamic or static storage device (e.g., flash memory, magnetic memory, optical memory, etc.) that stores information and/or software instructions for use by the processor. Memory 2604 may include a computer-readable medium and/or storage component. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 2604 from another computer-readable medium or from another device via a communication interface with computing device. When executed, software instructions stored in memory 2604 may cause the processor to perform one or more processes described herein. Embodiments described herein are not limited to any specific combination of hardware circuitry and software.

The memory 2604 can be a non-transitory computer-readable medium. The term “computer-readable medium” (or “machine-readable medium”) as used herein is an extensible term that refers to any medium or any memory, which participates in providing instructions to the processor for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, transmission media, etc. The computer or machine-readable medium can be configured to store one or more instructions thereon. The instructions can be in the form of algorithms, program logic, etc. that cause the processor to execute any of the functions disclosed herein.

Embodiments of the memory 2604 can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, waveguides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Data stored in the exemplary computing system 2600 (e.g., in the memory) can be stored on any type of suitable computer readable media, such as optical storage (e.g., a compact disc, digital versatile disc, Blu-ray disc, etc.), magnetic tape storage (e.g., a hard disk drive), or solid-state drive. An operating system can also be stored in the memory 2604.

In an exemplary embodiment, the data can be configured in any type of suitable database configuration, such as a relational database, a structured query language (SQL) database, a distributed database, an object database, etc. According to an exemplary embodiment, the data can be stored on one or more device configured to operate as cloud storage on a network. Suitable configurations and storage types will be apparent to persons having skill in the relevant art.

The exemplary computing device can also include a communications interface 2610. The communications interface 2610 can be configured to allow software and data to be transferred between the computing device and external devices. Exemplary communications interfaces can include a modem, a network interface (e.g., an Ethernet card), a communications port, a PCMCIA slot and card, etc. Software and data transferred via the communications interface and be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Memory semiconductors (e.g., DRAMs, etc.) can be means for providing software to the computing device. Computer programs (e.g., computer control logic) can be stored in the memory. Computer programs can also be received via the communications interface. Such computer programs, when executed, can enable computing device to implement the present methods as discussed herein. In particular, the computer programs stored on a non-transitory computer-readable medium, when executed, can enable hardware processor device to implement the methods as discussed herein. Accordingly, such computer programs can represent controllers of the computing device.

According to exemplary embodiments described herein, the combination of the memory 2604 and the processor 2602 can store and/or execute computer program code for performing the specialized functions described herein. The program code can be stored on a non-transitory computer readable medium, such as the memory devices for the computing device, which may be memory semiconductors (e.g., DRAMs, etc.) or other tangible and non-transitory means for providing software to the computing device. For example, via any known or suitable service or platform, the program code can be deployed (e.g., streamed and/or downloaded) remotely from computing devices located on a local-area or wide-area network and/or in a cloud-computing arrangement or environment. In another example, the computer programs (e.g., computer control logic) or software may be stored in memory resident on/in the computing device. The computer programs or software may be stored in a computer program product or non-transitory computer readable medium and loaded into the computing device using any one or combination of a removable storage drive, an interface for internal or external communication, and a hard disk drive, where applicable. The computer programs or software, when executed, may enable the computing device to implement the present methods and exemplary embodiments discussed herein. Accordingly, such computer programs may represent controllers of the computing device.

The computing system 2600 or device may also include a receiver or receiving device 2612, an input/output (I/O) interface 2614, a transmitting device 2616, a communication infrastructure 2618, and an input device 2620. The computing system 2600 can be connected to a communication network and a database and/or cloud storage.

The receiver or receiving device 2612 may be a combination of hardware and software components configured to receive data samples from the mobile network or database. According to exemplary embodiments, the receiving device 2612 can include a hardware component such as an antenna, a network interface (e.g., an Ethernet card), a communications port, a Personal Computer Memory Card International Association (PCMCIA) slot and card, 5G New Radio (NR) interface, or any other component or device suitable for use on a mobile communication network or Radio Access Network as desired. The receiving device 2612 can be an input device for receiving signals and/or data samples formatted according to 3GPP protocols and/or standards. The receiving device 2612 can be connected to other devices via a wired or wireless network or via a wired or wireless direct link or peer-to-peer connection without an intermediate device or access point. The hardware and software components of the receiving device 2612 can be configured to receive the data from the mobile network according to one or more communication protocols and data formats. For example, the receiving device 2612 can be configured to communicate over a network, which may include a local area network (LAN), a wide area network (WAN), a wireless network (e.g., Wi-Fi), a mobile communication network, a satellite network, the Internet, fiber optic cable, coaxial cable, infrared, radio frequency (RF), another suitable communication medium as desired, or any combination thereof. During a receive operation, the receiving device 2612 can be configured to identify parts of the received data via a header and parse the data signal and/or data packet into small frames (e.g., bytes, words) or segments for further processing at the processor.

The I/O interface 2614 can be configured to receive the signal from the processor and generate an output suitable for a peripheral device via a direct wired or wireless link. The I/O interface 2614 can include a combination of hardware and software for example, a processor, circuit card, or any other suitable hardware device encoded with program code, software, and/or firmware for communicating with a peripheral device such as a display device, printer, audio output device, or other suitable electronic device or output type as desired.

The transmitting device 2616 can be configured to receive data from the processor and assemble the data into a data signal and/or data packets according to the specified communication protocol and data format of a peripheral device or remote device to which the data is to be sent. The transmitting device 2616 can include any one or more of hardware and software components for generating and communicating the data signal over the communications infrastructure 2618 and/or via a direct wired or wireless link to a peripheral or remote device. The transmitting device 2616 can be configured to transmit information according to one or more communication protocols and data formats as discussed in connection with the receiving device.

The input device 2620 is configured to receive an input from a user for processing and/or use by the CPU. For example, the input device 2620 can be implemented as a physical or virtual keyboard, a physical or virtual touchpad, a microphone, or any suitable device for inputting data or information as desired. The input device 2620 can be configured to format the received user input suitable for use by the CPU or be configured to provide the user input to the I/O interface 2614 for further processing. According to an exemplary embodiment, the input device 2620 can be configured to communicate wirelessly with the computing system or be integrated into the housing of the computing system or have a physical connection to the computing device. In performing the described operations, the input device 2620 can be configured to include a combination of hardware and software components.

In the context of exemplary embodiments of the present disclosure, a processor can include one or more modules or engines configured to perform the functions of the exemplary embodiments described herein. Each of the modules or engines may be implemented using hardware and, in some instances, may also utilize software, such as corresponding to program code and/or programs stored in memory. In such instances, program code may be interpreted or compiled by the respective processors (e.g., by a compiling module or engine) prior to execution. For example, the program code may be source code written in a programming language that is translated into a lower-level language, such as assembly language or machine code, for execution by the one or more processors and/or any additional hardware components. The process of compiling may include the use of lexical analysis, preprocessing, parsing, semantic analysis, syntax-directed translation, code generation, code optimization, and any other techniques that may be suitable for translation of program code into a lower-level language suitable for controlling the system to perform the functions disclosed herein. It will be apparent to persons having skill in the relevant art that such processes result in the system being a specially configured computing device uniquely programmed to perform the functions of the exemplary embodiments described herein.

Techniques consistent with the present disclosure provide, among other features, systems, and methods for managing routes and travel planning. While various illustrative embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

1. A method for a dynamic flight exchange, comprising:
storing, in memory of a computing device, program code for generating a dynamic flight exchange;
executing, by a processor of the computing device, the program code stored in memory, the program code causing the computing device to be configured to execute operations including:
generating, by the processor, an application programming interface for generating plural provider dashboards, each provider dashboard providing a first interactive display for a resale of previously purchased charter flight assets including at least previously purchased jet card hours;
receiving, by the processor via the application programming interface, a user input corresponding to the first interactive display of one of the plural provider dashboards, the user input including plural parameter values parameters associated with one of the resale or the purchase of a target charter flight asset;
initiating, by the processor, an exchange event at a server, the exchange event including one of:
a query based on the user input associated with the purchase of the target charter flight asset, and
an online auction based on the user input associated with the resale of the target charter flight asset;
receiving, by the processor, data in response to an exchange event from the network, the data including information obtained in response to the query or data in response to the sale of the target charter flight asset;
generating, by the user interface, a second interactive display including an arrangement of data received in response to the exchange event, the second interactive display being configured to accept a user response to the arrangement of data;
receiving, by the user interface, the user response to the arrangement of data; and
controlling, by the processor, the exchange event executed by the server based on user response data, the user response data causing the server to end the exchange based on a booking of the previously purchased charter flight asset.

2. The method of claim 1, wherein the target charter flight asset includes one or more resale spaces available on a charter flight by a purchaser.

3. The method of claim 2, wherein the user input includes a flight date, a flight route, and a static price value for the one or more spaces for resale on the charter flight.

4. The method of claim 2, wherein the user input includes a flight date, a variable price value for the one or more resale spaces available on the charter flight, an updated variable price associated with a number of resale spaces to be purchased.

5. (canceled)

6. The method of claim 1 wherein the user input includes a number of hours for sale, a price per hour at a market rate, and a starting bid value.

7. The method of claim 1, wherein the target charter flight asset includes a charter associated with the previously purchased charter flight asset.

8. The method of claim 7, wherein the user input includes a flight date, a flight route, a variable price value, a starting bid, a time interval for updating the variable price value, and an updated variable price associated with the time interval.

9. The method of claim 1, wherein the target charter flight asset includes a charter aircraft available for reservation using the previously purchased charter flight asset, and the user input includes a flight route and a flight date for generating the query.

10. The method of claim 1, wherein the target charter flight asset includes the previously purchased jet card hours for purchase, and the user input includes a minimum number of hours, a maximum price, a preferred provider, and an aircraft type for generating the query.

11. The method of claim 1, wherein the target flight asset includes one or more previously purchased spaces available for purchase, and the user input includes a flight route and a flight date for generating the query.

12. The method of claim 1, wherein the second interactive display includes a list of previously purchased candidate charter flight assets returned in response to the query.

13. The method of claim 1, wherein the second interactive display includes new bid values in response to a previous bid value of the online auction.

14. The method of claim 1, wherein controlling the exchange event comprises:
generating, by the user interface, a third interactive display for completing purchase of a selected candidate charter flight asset from a list of candidate charter flight assets received in response to the query; and
sending, by the processor, a signal over the network to remove a selected candidate charter flight asset from available charter flight assets when the purchase of the selected candidate charter flight asset is completed through the user interface.

15. The method of claim 1, wherein controlling the exchange event comprises:
generating, by the user interface, a third interactive display for accepting a current bid for the target charter flight asset received over the network in response to the online auction; and
sending, by the processor, a signal over the network to close the online auction for the target charter flight asset when the current bid is accepted through the user interface.

16. A system for a dynamic flight exchange, comprising:
memory configured for storing program code for generating a dynamic flight exchange;
a processor configured to execute the program code stored in memory, the program code causing the processor to be configured to generate an application programming interface for generating plural provider dashboards, each provider dashboard providing a first interactive display for a resale of previously purchased charter flight assets including at least previously purchased jet card hours;
a user interface configured to receive a user input corresponding to the first interactive display of one of the plural provider dashboards, the user input including plural parameter values parameters associated with one the resale or the purchase of a target charter flight asset;
the processor being configured to:
initiate an exchange event on a public network through a server, the exchange event including one of:
a query the server based on the user input associated with the purchase of the target charter flight asset, and
an online auction running on the server based on the user input associated with the sale of the target charter flight asset;
receive, from the server, data in response to an exchange event, the data including information obtained in response to the query or data in response to the resale of the target charter flight asset;
the user interface being configured to:
generate a second interactive display including an arrangement of data received from the server in response to the exchange event, the second interactive display being configured to accept a user response to the arrangement of data; and
receive the user response to the arrangement of data; and
the processor being configured to control the exchange event on the network based on user response data, the user response data causing the server to end the exchange based on a booking of the previously purchased charter flight asset.

17. A non-transitory computer readable medium storing program code for a dynamic flight exchange, when placed in communicable contact with a computing device, the computer readable medium causing the computing device to be configured to:
generate an application programming interface for generating plural provider dashboards, each provider dashboard providing a first interactive display for resale of previously purchased charter flight assets including at least previously purchased jet card hours;
receive a user input corresponding to the first interactive display of one of the plural provider dashboards, the user input including plural parameter values parameters associated with the resale of a target charter flight asset;
initiate an exchange event on a public network through a server the exchange event including one of:
a query based on the user input associated with the purchase of the target charter flight asset, and
an online auction based on the user input associated with the sale of the target charter flight asset;
receive data in response to an exchange event, the data including information obtained in response to the query or data in response to the resale of the target charter flight asset;
generate a second interactive display including an arrangement of data received in response to the exchange event, the second interactive display being configured to accept a user response to the arrangement of data; and
receive, the user response to the arrangement of data; and
send user response data to the server to control, the exchange event based on the user response, the user response data causing the server to end the exchange based on a booking of the previously purchased charter flight asset.
